(19) United States
(12) Patent Application Publication
(10) Pub. No.: US 2021/0146476 A1
(43) Pub. Date: May 20, 2021

(54) STEALTH DICING APPARATUS AND STEALTH DICING METHOD

(71) Applicant: Samsung Electronics Co., Ltd., Suwon-si (KR)

(72) Inventors: Youngchul KWON, Asan-si (KR); Changhyun KIM, Seoul (KR); Byoungho LEE, Seoul (KR); Jangwoon SUNG, Seoul (KR); Junhyeok JANG, Seoul (KR); Chulsoo CHOI, Seoul (KR); Manhee HAN, Cheonan-si (KR)

(73) Assignees: Samsung Electronics Co., Ltd., Suwon-si (KR); Seoul National University, R&DB Foundation, Seoul (KR)

(21) Appl. No.: 16/906,410

(22) Filed: Jun. 19, 2020

(30) Foreign Application Priority Data
Nov. 15, 2019 (KR) 10-2019-0146363

(51) Int. Cl. B23K 26/06; B23K 26/073

(52) U.S. Cl. CPC B23K 26/0613; B23K 26/0738

(57) ABSTRACT

A stealth dicing apparatus may include a laser light source, and a linearly focusing lens configured to linearly focus a beam output from the laser light source. The linearly focusing lens includes a horizontal surface, and an inclined surface forming an inclination angle with the horizontal surface. The inclination angle satisfies an expression 34.97R²−146.6R+162.5<α<52.45R²−207.6R+224.9, where ‘α’ is the inclination angle and ‘R’ is a refractive index of the linearly focusing lens.

### CROSS-REFERENCE TO RELATED APPLICATION

This U.S. non-provisional patent application claims priority under 35 U.S.C. § 119 to Korean Patent Application No. 10-2019-0146363, filed on Nov. 15, 2019, in the Korean Intellectual Property Office, the disclosure of which is hereby incorporated by reference in its entirety.

### BACKGROUND

Example embodiments of the inventive concepts relate to stealth dicing apparatuses and/or stealth dicing methods, and more particularly, to stealth dicing apparatuses and/or stealth dicing methods capable of linearly focusing a laser beam.

Semiconductor manufacturing processes may include various processes. For example, the semiconductor manufacturing processes may include a process of cutting or dicing a wafer. The wafer may be cut or diced by at least one of various methods. The wafer may be cut or diced using a blade. Alternatively, the wafer may be cut or diced using a laser. A stealth dicing method of focusing a laser beam in the wafer may be used to cut or dice the wafer using the laser. A crack may be generated in a portion of the wafer, which the laser beam has been focused. The wafer may be cut based on the portion in which the crack is generated.

### SUMMARY

Some example embodiments of the inventive concepts may provide stealth dicing apparatuses and/or methods capable of cutting a wafer through one process.

Some example embodiments of the inventive concepts may also provide stealth dicing apparatuses and/or methods capable of cutting a thick wafer.

Some example embodiments of the inventive concepts may further provide stealth dicing apparatuses and/or methods capable of quickly and easily cutting a wafer.

Some example embodiments of the inventive concepts may further provide stealth dicing apparatuses and/or methods capable of improving productivity while using a dicing before grinding (DBG) method.

In an aspect, a stealth dicing apparatus may include a laser light source, and a linearly focusing lens configured to linearly focus a beam output from the laser light source. The linearly focusing lens may include a horizontal surface, and an inclined surface forming an inclination angle with the horizontal surface. The inclination angle may satisfy an expression 34.97R²−146.6R+162.5<α<52.45R²−207.6R+224.9, where ‘α’ is the inclination angle and ‘R’ is a refractive index of the linearly focusing lens.

In an aspect, a stealth dicing apparatus may include a laser light source, and a linearly focusing lens configured to linearly focus a beam output from the laser light source. The linearly focusing lens may include a cylindrical lens, and a conical lens coupled to a bottom surface of the cylindrical lens. A side surface of the conical lens may form an inclination angle with the bottom surface of the cylindrical lens. The inclination angle may satisfy an expression 34.97R²−146.6R+162.5<α<52.45R²−207.6R+224.9, where ‘α’ is the inclination angle and ‘R’ is a refractive index of the linearly focusing lens.

In an aspect, a stealth dicing method may include adjusting a size of a beam by controlling a beam size adjuster, refracting the beam by a linearly focusing lens, linearly focusing the refracted beam in a wafer, and forming a crack in the wafer by the linearly focused beam. The linearly focusing lens may include a horizontal surface, and an inclined surface forming an inclination angle with the horizontal surface. The inclination angle may satisfy an expression 34.97R²−146.6R+162.5<α<52.45R²−207.6R+224.9, where ‘α’ is the inclination angle and ‘R’ is a refractive index of the linearly focusing lens.

### BRIEF DESCRIPTION OF THE DRAWINGS

The inventive concepts will become more apparent in view of the attached drawings and accompanying detailed description.

FIG. 1A is a conceptual view illustrating a stealth dicing apparatus according to some example embodiments of the inventive concepts.

FIG. 1B is a flowchart illustrating a stealth dicing method according to some example embodiments of the inventive concepts.

FIG. 2A is a conceptual view illustrating an operation principle of a beam size adjuster according to some example embodiments of the inventive concepts.

FIG. 2B is a conceptual view illustrating an operation principle of a beam size adjuster according to some example embodiments of the inventive concepts.

FIG. 3 is a conceptual view illustrating an operation principle of a stealth dicing apparatus according to some example embodiments of the inventive concepts.

FIGS. 4 to 8 are conceptual views illustrating a dicing process by a stealth dicing apparatus according to some example embodiments of the inventive concepts.

FIG. 9 is a graph showing simulation results of a full width at half maximum (FWHM) and an intensity, obtained when using a stealth dicing apparatus according to some example embodiments of the inventive concepts.

FIG. 10 is a graph showing simulation results of a depth of focus (DOF), obtained when using a stealth dicing apparatus according to some example embodiments of the inventive concepts.

FIG. 11 is a graph showing simulation results of a ratio of a leakage beam obtained when using a stealth dicing apparatus according to some example embodiments of the inventive concepts.

FIG. 12 is a graph showing simulation results of a full width at half maximum (FWHM) obtained when using a stealth dicing apparatus according to some example embodiments of the inventive concepts.

FIG. 13 is a graph showing simulation results of an appropriate ratio of a refractive index of a linearly focusing lens and an inclination angle, obtained when using a stealth dicing apparatus according to some example embodiments of the inventive concepts.

FIG. 14 is a graph showing simulation results of a temperature distribution in a wafer, obtained when using a stealth dicing apparatus according to some example embodiments of the inventive concepts.

FIG. 15 is a graph showing simulation results of a stress distribution in a wafer, obtained when using a stealth dicing apparatus according to some example embodiments of the inventive concepts.

### DETAILED DESCRIPTION OF THE EXAMPLE EMBODIMENTS

Hereinafter, example embodiments of the inventive concepts will be described in detail with reference to the accompanying drawings. The same reference numerals or the same reference designators may denote the same elements or components throughout the specification.

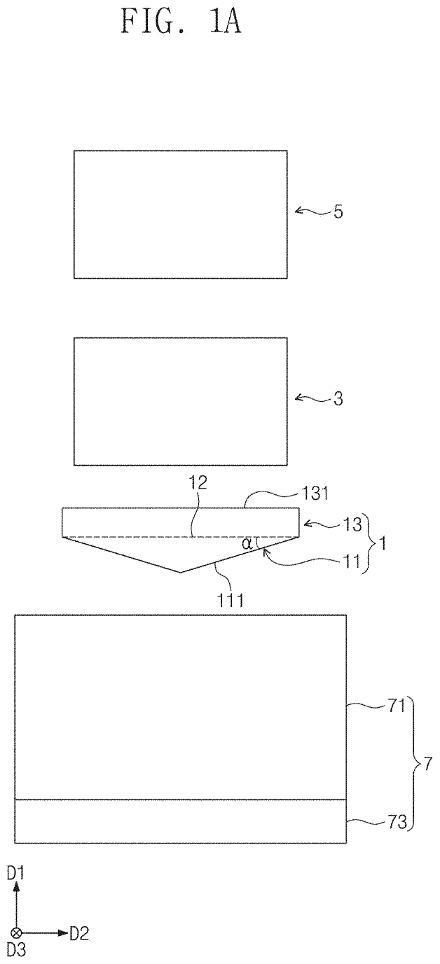

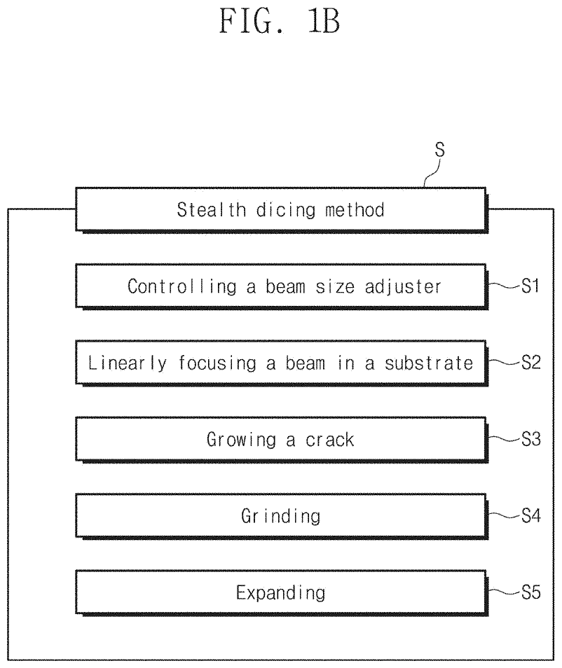

FIG. 1A is a conceptual view illustrating a stealth dicing apparatus according to some example embodiments of the inventive concepts.

When the terms “about” or “substantially” are used in this specification in connection with a numerical value, it is intended that the associated numerical value includes a manufacturing or operational tolerance (e.g., ±10%) around the stated numerical value. Moreover, when the words “generally” and “substantially” are used in connection with geometric shapes, it is intended that precision of the geometric shape is not required but that latitude for the shape is within the scope of the disclosure. Further, regardless of whether numerical values or shapes are modified as “about” or “substantially,” it will be understood that these values and shapes should be construed as including a manufacturing or operational tolerance (e.g., ±10%) around the stated numerical values or shapes.

Hereinafter, a reference designator ‘D1’ of FIG. 1A may be referred to as a first direction, and a reference designator ‘D2’ of FIG. 1A may be referred to as a second direction. The first direction D1 and second direction D2 may be in the same plane and substantially perpendicular. A reference designator ‘D3’ substantially perpendicular to the first and second directions D1 and D2 in FIG. 1A may be referred to as a third direction.

Referring to FIG. 1A, a substrate 7 may be cut or diced using a stealth dicing apparatus according to some example embodiments of the inventive concepts. The stealth dicing apparatus may include a laser light source 5, a beam size adjuster 3, and a linearly focusing lens 1.

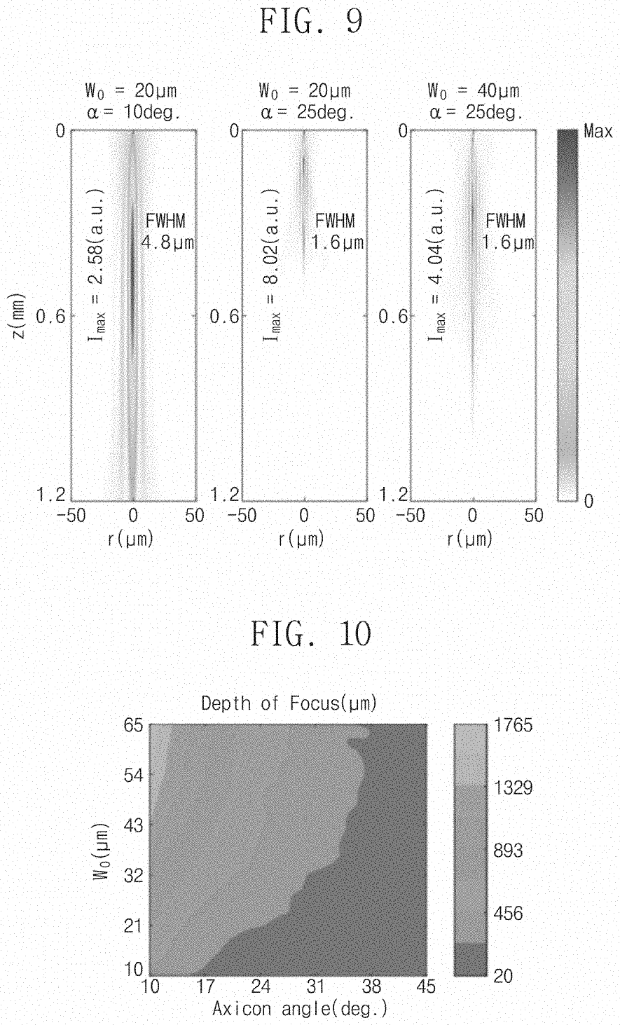

The laser light source 5 may irradiate a laser beam. The laser light source 5 may irradiate a laser beam capable of cutting a wafer 71. The irradiated laser beam may include pulse laser. In some example embodiments, a pulse width of the irradiated pulse laser beam may be 100 ns or less. In some example embodiments, the average power of the laser beam may be 2 W or more. The laser beam will be described later in more detail with reference to FIGS. 9 to 15.

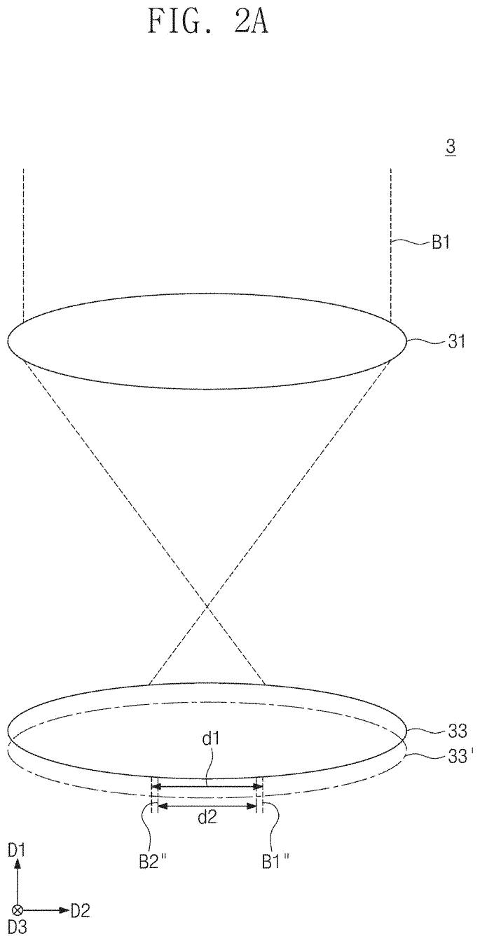

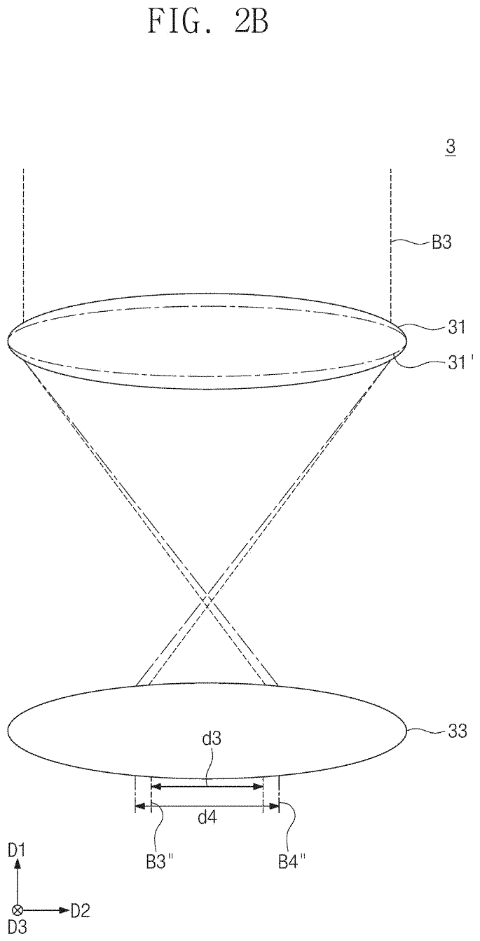

The beam size adjuster 3 may adjust a size of a beam. The beam size adjuster 3 may be located between the laser light source 5 and the linearly focusing lens 1. The beam size adjuster 3 may transmit a beam emitted from the laser light source 5 to the linearly focusing lens 1. The beam size adjuster 3 will be described later in more detail with reference to FIGS. 2A and 2B.

The linearly focusing lens 1 may include a material capable of transmitting the laser beam. In some example embodiments, the linearly focusing lens 1 may include glass. A beam outputted from the beam size adjuster 3 may be incident on the linearly focusing lens 1. The beam may be transmitted through the linearly focusing lens 1. The beam may be refracted when exiting from the linearly focusing lens 1. The refracted beam may be focused into a certain region. The refracted beam may be linearly focused in the certain region. That is, the refracted beam may be focused as a Bessel-like beam (BLB) in the certain region. In other words, the linearly focusing lens 1 may convert a Gaussian beam into the Bessel-like beam (BLB). The refracted beam may be linearly focused in the substrate 7. In some example embodiments, the linearly focusing lens 1 may include a conical lens 11 and a cylindrical lens 13. The conical lens 11 may include a horizontal surface 12. An inclined surface 111 may be a portion of the conical lens 11. The horizontal surface 12 may be substantially perpendicular to the first direction D1. In some example embodiments, the horizontal surface 12 may be an interface between the conical lens 11 and the cylindrical lens 13. The laser beam may pass through the horizontal surface 12. The laser beam may pass through the horizontal surface 12 in a direction substantially perpendicular to the horizontal surface 12. In some example embodiments, a diameter of the laser beam incident on the horizontal surface 12 may range from 20 μm to 40 μm. However, example embodiments of the inventive concepts are not limited thereto. The laser beam may be transmitted into the inside of the conical lens 11 through the horizontal surface 12. The laser beam transmitted through the inside of the conical lens 11 may pass through the inclined surface 111. The laser beam may exit from the linearly focusing lens 1 through the inclined surface 111. The inclined surface 111 may form a side surface of a cone. The inclined surface 111 may form an inclination angle α with the horizontal surface 12. The inclination angle α may have a relation with a refractive index R of the linearly focusing lens 1. In some example embodiments, the relation of the inclination angle α and the refractive index R may be represented by the following expression (1).

34.97R²−146.6R+162.5<α<52.45R²−207.6R+224.9 expression (1) (degree)

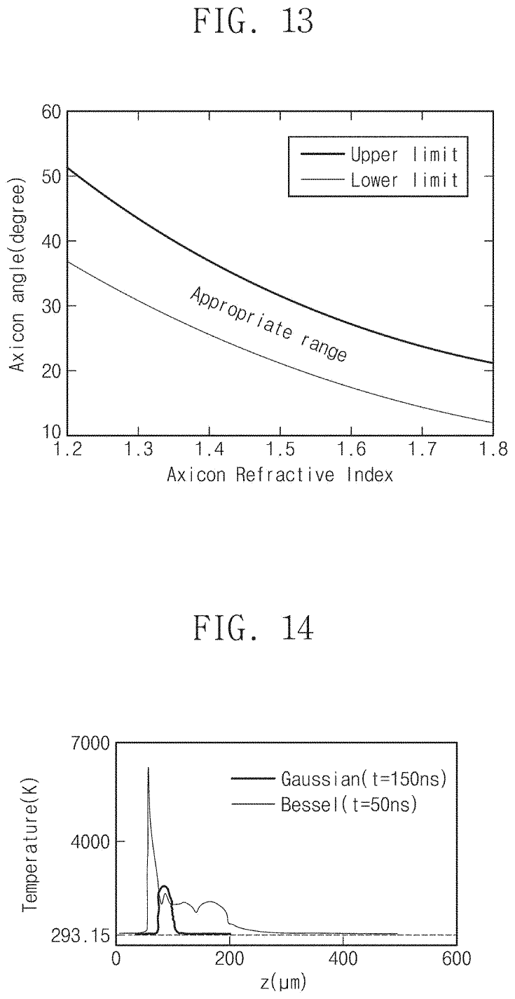

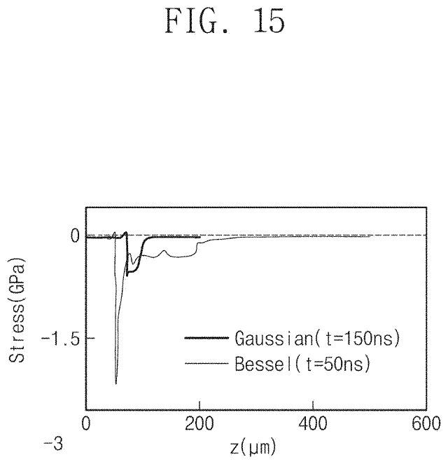

When the inclination angle α is in the range of the expression (1) with respect to the refractive index R of the linearly focusing lens 1, the cutting ability of the beam linearly focused by the linearly focusing lens 1 may be optimized. In some example embodiments, the inclination angle α may range from 25 degrees to 35 degrees. This will be described later in more detail with reference to FIG. 14. The cylindrical lens 13 may be coupled to the conical lens 11. The cylindrical lens 13 may be coupled to a top side of the conical lens 11. The cylindrical lens 13 may be coupled to the horizontal surface 12 of the conical lens 11. The cylindrical lens 13 and the conical lens 11 may share the horizontal surface 12. In some example embodiments, the cylindrical lens 13 and the conical lens 11 may be formed in a single unitary body. The cylindrical lens 13 may include an incident surface 131. The incident surface 131 may be substantially perpendicular to the first direction D1. Thus, the incident surface 131 may be substantially parallel to the horizontal surface 12. The laser beam may be incident on the incident surface 131. The laser beam may enter the linearly focusing lens 1 through the incident surface 131. In certain example embodiments, the linearly focusing lens 1 may include only the conical lens 11. In other words, the linearly focusing lens 1 may include only the conical lens 11 without the cylindrical lens 13.

The substrate 7 may include the wafer 71 and a circuit layer 73. In some example embodiments, the wafer 71 may include a semiconductor material. For example, the wafer 71 may include silicon. The circuit layer 73 may include a conductive material. More particularly, the circuit layer 73 may include transistors and interconnection lines.

FIG. 1B is a flowchart illustrating a stealth dicing method according to some example embodiments of the inventive concepts.

Referring to FIG. 1B, a stealth dicing method (S) may include controlling a beam size adjuster (S1), linearly focusing a beam in a wafer (S2), growing a crack (S3), grinding (S4), and expanding (S5).

Hereinafter, the steps of the stealth dicing method (S) will be described in detail with reference to FIGS. 2A to 8.

FIG. 2A is a conceptual view illustrating an operation principle of a beam size adjuster according to some example embodiments of the inventive concepts, and FIG. 2B is a conceptual view illustrating an operation principle of a beam size adjuster according to some example embodiments of the inventive concepts.

Referring to FIG. 2A, the beam size adjuster 3 may include a front lens 31 and a rear lens 33. The front lens 31 may include a variable thickness lens. The rear lens 33 may include a variable position lens. A position of the rear lens 33 may be variable or changeable. A size of the laser beam may be changed by changing the position of the rear lens 33. In other words, a diameter of the laser beam outputted from the beam size adjuster 3 may be changed by changing the position of the rear lens 33. In some example embodiments, the position of the rear lens 33 may be moved in the first direction D1 and/or a direction opposite to the first direction D1. When the rear lens 33 is moved, a size of the laser beam transmitted through the rear lens 33 may be changed. For example, when a laser beam B1 transmitted through the front lens 31 passes through the rear lens 33 located at a first position, a laser beam B1″ outputted from the rear lens 33 may have a first diameter d1. When the rear lens 33 is moved in the direction opposite to the first direction D1, a laser beam B2″ transmitted through the moved rear lens 33′ may have a second diameter d2. The first diameter d1 may be different from the second diameter d2. The size of the laser beam may be adjusted by the above method.

Referring to FIG. 2B, a thickness of the front lens 31 may be variable or changeable. The size of the laser beam may be changed by changing the thickness of the front lens 31. In other words, the diameter of the laser beam outputted from the beam size adjuster 3 may be changed by changing the thickness of the front lens 31. For example, a laser beam B3 may pass through the front lens 31 and the rear lens 33. When the front lens 31 has a first thickness, a laser beam B3″ transmitted through the rear lens 33 may have a third diameter d3. When a front lens 31′ has a second thickness by changing the thickness of the front lens 31, a laser beam B4″ transmitted through the rear lens 33 may have a fourth diameter d4. The third diameter d3 may be different from the fourth diameter d4. The size of the laser beam may be adjusted by the above method. In some example embodiments, the front lens 31 may include a flexible material. A fluid may be provided in the flexible material of the front lens 31. In other words, the front lens 31 may have a structure in which the fluid fills the inside of the flexible material. The thickness of the front lens 31 may be adjusted by stretching or compressing the front lens 31.

The controlling of the beam size adjuster (S1) may include changing the thickness of the front lens 31. The size of the laser beam may be adjusted by changing the thickness of the front lens 31. The controlling of the beam size adjuster (S1) may include changing the position of the rear lens 33. The size of the laser beam may be adjusted by changing the position of the rear lens 33. Thus, the size of the laser beam may be appropriately controlled by controlling the front lens 31 and/or the rear lens 33. In some example embodiments, the size (e.g., the diameter) of the laser beam may be adjusted to several tens micrometers (μm) in the controlling of the beam size adjuster (S1). More particularly, the size of the laser beam may range from 20 μm to 40 μm. This will be described later in more detail.

In the stealth dicing apparatus and method according to the example embodiments of the inventive concepts, the size (diameter) of the laser beam to be incident on the linearly focusing lens may be adjusted by the beam size adjuster. Thus, it may be easy to adjust an intensity, a length and/or a full width at half maximum (FWHM) of the laser beam linearly focused in a region. As a result, a wafer may be effectively cut.

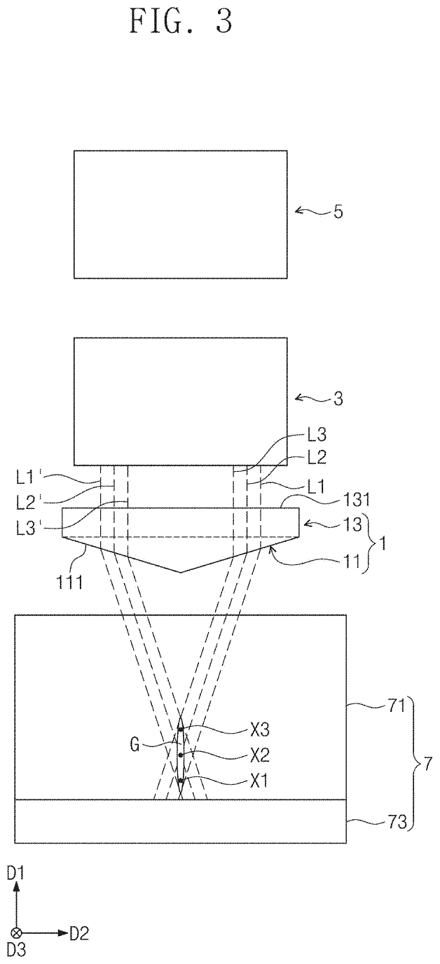

FIG. 3 is a conceptual view illustrating an operation principle of a stealth dicing apparatus according to some example embodiments of the inventive concepts.

Referring to FIG. 3, the linear focusing of the beam in the wafer (S2) may include linearly focusing a laser beam refracted through the linearly focusing lens 1 in the wafer 71. In some example embodiments, the laser beam emitted from the laser light source 5 may be transmitted through the beam size adjuster 3 to have an appropriate size and then may be incident on the linearly focusing lens 1. More particularly, the laser beam may be incident into the cylindrical lens 13 through the incident surface 131. The laser beam transmitted through the cylindrical lens 13 may be incident into the conical lens 11 through the horizontal surface 12. The laser beam may be outputted from the conical lens 11 through the inclined surface 111. The laser beam may be bent due to a difference in refractive index between mediums while passing through the inclined surface 111. In other words, the laser beam may be refracted while passing through the inclined surface 111. More particularly, the laser beam may be refracted toward a vertex of the conical lens 11 while passing through the inclined surface 111. For example, a right outer ray L1 of the laser beam may be refracted to the left while passing through the inclined surface 111. A left outer ray L1′ of the laser beam may be refracted to the right while passing through the inclined surface 111. A right middle ray L2 of the laser beam may be refracted to the left while passing through the inclined surface 111. A left middle ray L2′ of the laser beam may be refracted to the right while passing through the inclined surface 111. A right inner ray L3 of the laser beam may be refracted to the left while passing through the inclined surface 111. A left inner ray L3′ of the laser beam may be refracted to the right while passing through the inclined surface 111. The refracted right outer ray L1 may meet the refracted left outer ray L1′ in the wafer 71. The refracted right outer ray L1 and the refracted left outer ray L1′ may be focused at a lower focal point X1 by constructive interference. The refracted right middle ray L2 may meet the refracted left middle ray L2′ in the wafer 71. The refracted right middle ray L2 and the refracted left middle ray L2′ may be focused at a middle focal point X2 by constructive interference. The refracted right inner ray L3 may meet the refracted left inner ray L3′ in the wafer 71. The refracted right inner ray L3 and the refracted left inner ray L3′ may be focused at an upper focal point X3 by constructive interference. Other focal points may exist continuously between the lower focal point X1, the middle focal point X2 and the upper focal point X3. A plurality of the focal points may be aligned on a straight line parallel to the first direction D1. Thus, the laser beam may be focused in the form of a line extending in the first direction D1 in the wafer 71. In other words, the laser beam may be linearly focused in the wafer 71. For example, the laser beam may be focused as a Bessel-like beam (BLB) in the wafer 71. A region in which the laser beam is focused may extend in the second direction D2 and the third direction D3 by certain lengths from the line formed by the plurality of focal points. In some example embodiments, a focal region G may have a shape having a long axis parallel to the first direction D1. In some example embodiments, a length, in the first direction D1, of the long axis of the focal region G may range from about 150 μm to about 200 μm. However, example embodiments of the inventive concepts are not limited thereto. The long axis of the focal region G may have another length.

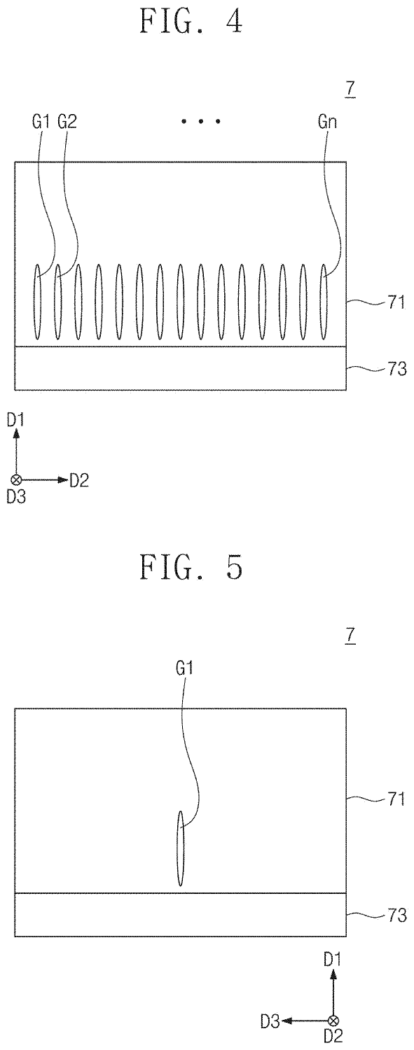

FIGS. 4 to 6 are conceptual views illustrating a dicing process by a stealth dicing apparatus according to some example embodiments of the inventive concepts.

Referring to FIG. 4, the process of forming the focal region may be performed a plurality of times by the stealth dicing apparatus. The stealth dicing apparatus may sequentially perform the processes while moving in the second direction D2. Thus, the focal region may be provided in plurality. The plurality of focal regions may be spaced apart from each other in the second direction D2. The leftmost focal region may be referred to as a first focal region G1. A focal region on the right of the first focal region G1 may be referred to as a second focal region G2. n focal regions G1, G2, . . . Gn may be provided.

Referring to FIG. 5, the plurality of focal regions G1, G2, . . . Gn may completely overlap with each other when viewed in a cross-sectional view. In other words, the plurality of focal regions G1, G2, . . . Gn may be aligned with each other on a plane D1-D2 defined by the first direction D1 and the second direction D2.

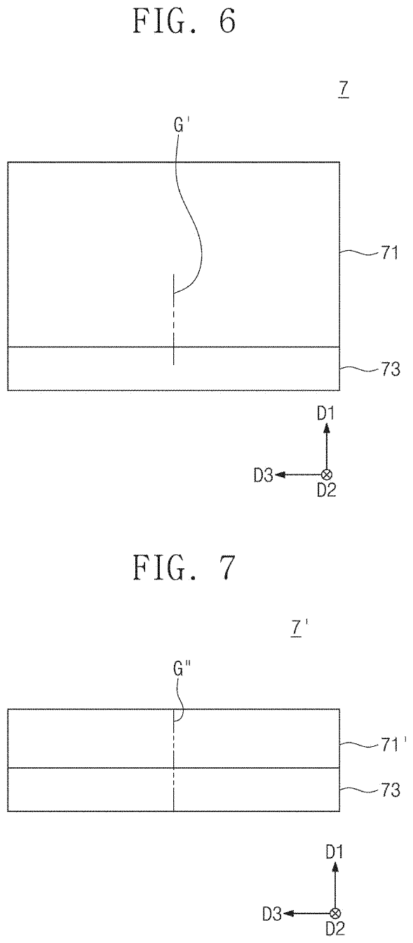

Referring to FIG. 6, a crack line G′ may be generated along the plurality of focal regions G1, G2, . . . Gn aligned on the same plane D1-D2. More particularly, a crack may be generated in the wafer 71 by energy of the laser beam linearly focused in the focal region G, and thus the crack line G′ may be formed. In some example embodiments, the growing of the crack (S3, see FIG. 1B) may include growing the crack line G′ in the first direction D1. In some example embodiments, the grown crack line G′ may extend to the circuit layer 73. In some example embodiments, a center of the crack line G′ may be located in a range of 50 μm to 100 μm from a bottom of the wafer 71. In some example embodiments, the growing of the crack (S3) may include growing the crack line G′ in the second direction D2. In other words, the crack line G′ may be grown along the plane D1-D2 defined by the first direction D1 and the second direction D2.

In the stealth dicing apparatus and method according to the example embodiments of the inventive concepts, the laser beam may be linearly focused. Thus, the wafer may be cut by one laser process. A thick wafer may also be cut by one laser process. Thus, a dicing process of the wafer may be quickly performed, and a time of total processes may be reduced. As a result, a process cost may be reduced.

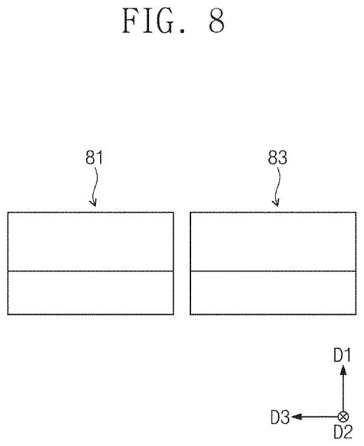

FIGS. 7 and 8 are conceptual views illustrating a dicing process by a stealth dicing apparatus according to some example embodiments of the inventive concepts.

Referring to FIG. 7, the grinding (S4, see FIG. 1B) may include grinding an upper portion of the wafer 71. The grinding process may grind the wafer 71. An unnecessary portion of the wafer 71 may be removed. Thus, a thickness of the ground wafer 71′ may be reduced. In some example embodiments, a length of a crack line G″ may be increased. In other words, the crack line G″ may be more grown. The crack line G″ may be grown in the first direction D1. For example, the crack line G″ may be grown to the vicinity of a bottom surface of the circuit layer 73.

In the stealth dicing apparatus and method according to the example embodiments of the inventive concepts, the grinding process may be performed after the dicing process. In other words, a dicing before grinding (DBG) method may be used. Thus, a phase change region by the laser beam may not remain in the wafer. As a result, a breaking strength of the wafer may be improved, and the wafer may be more solid. In addition, since the linearly focused laser beam is used, a thick wafer may be cut at one time. Thus, a thick wafer before grinding may be cut at one time. As a result, a process time may be reduced even in the DBG method.

Referring to FIG. 8, the expanding (S5, see FIG. 1B) may include expanding the ground wafer 71′ (see FIG. 7). More particularly, the wafer 71′ may receive a force in the second direction D2 and/or the third direction D3. Portions of the wafer 71′ may be separated from each other on the basis of the crack line by the force provided in the second direction D2 and/or the third direction D3. In other words, the wafer 71′ and/or the circuit layer 73 may be divided into a plurality of semiconductor chips 81 and 83 separated from each other in the second direction D2 and/or the third direction D3. The expanding process may be performed using an expanding tape (not shown). The expanding tape may be adhered to a bottom surface of the substrate 7′, and the force may be applied to the expanded tape in the second direction D2 and/or the third direction D3. Thus, the expanding tape may be expanded in the second direction D2 and/or the third direction D3. As a result, the substrate 7′ may also receive the force in the second direction D2 and/or the third direction D3 and thus may be divided into the plurality of semiconductor chips 81 and 83.

FIG. 9 is a graph showing simulation results of a full width at half maximum (FWHM) and an intensity, obtained when using a stealth dicing apparatus according to some example embodiments of the inventive concepts.

Referring to FIG. 9, three graphs may be provided. Each of the graphs may show a shape of a focal region of a laser beam focused in a wafer. When the linearly focusing lens 1 (see FIG. 1A) is used, the laser beam may be linearly focused. In other words, the laser beam may be focused linearly in a thickness direction of the wafer in the wafer. A symbol W₀ may mean the size (diameter) of the laser beam incident on the linearly focusing lens 1 (see FIG. 1A). The W₀ may be adjusted by the beam size adjuster. A symbol α may mean the inclination angle. In other words, the α may mean an angle between the horizontal surface 12 (see FIG. 1A) and the inclined surface 111 (see FIG. 1A). A symbol ‘z’ of a vertical axis may mean a height in the first direction D1 in the wafer. A symbol ‘r’ of a horizontal axis may mean a width in the second direction D2 in the wafer. A symbol Iₘₐₓ may mean an intensity of the focused laser beam. A full width at half maximum (FWHM) may mean a horizontal length (full width) at a position at which the intensity of a beam is a half of the maximum value. In other words, the FWHM may be correlated with a width of the focused laser beam. As the FWHM decreases, focusing strength may increase. Thus, the cutting ability by the focused laser beam may increase as the FWHM decreases. A length of the focused laser beam in the first direction D1 may be referred to as a depth of focus (DOF).

Referring to FIG. 9, when the beam size W₀ is constant, the FWHM, the DOF and the intensity of the focused laser beam may be changed depending on the inclination angle α. In addition, when the inclination angle α is constant, the FWHM, the DOF and the intensity of the focused laser beam may be changed depending on the beam size W₀. In other words, the FWHM, the DOF and the intensity of the laser beam linearly focused in the wafer may be controlled by adjusting the inclination angle α and the beam size W₀.

FIG. 10 is a graph showing simulation results of a depth of focus (DOF), obtained when using a stealth dicing apparatus according to some example embodiments of the inventive concepts. Referring to FIG. 10, the depth of focus may mean a focusing length. An axicon angle may mean the inclination angle α. The focusing length (depth of focus) may increase as the inclination angle α increases. In addition, the focusing length (depth of focus) may increase as the beam size W₀ decreases.

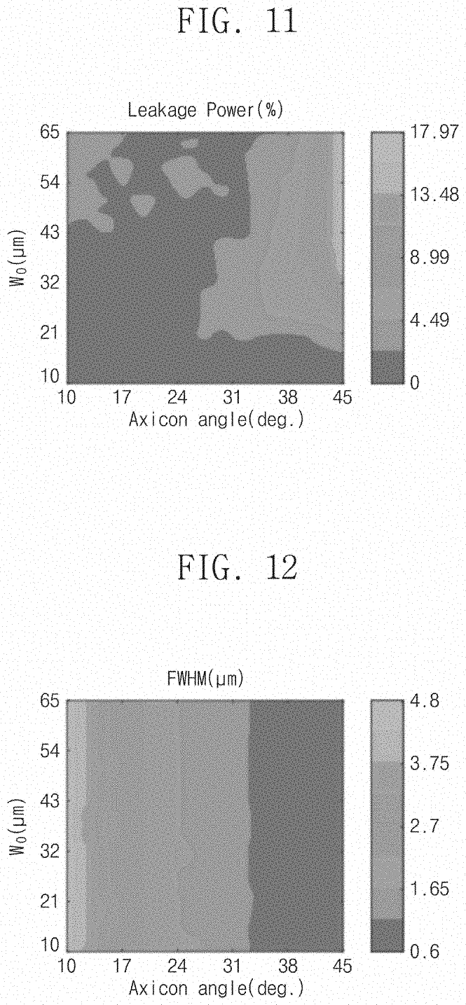

FIG. 11 is a graph showing simulation results of a ratio of a leakage beam obtained when using a stealth dicing apparatus according to some example embodiments of the inventive concepts. Referring to FIG. 11, leakage power (i.e., a ratio of a leakage beam) may mean a ratio deviating by 30 μm or more from a center line of the focused laser beam. The leakage power (the ratio of the leakage beam) may increase as the inclination angle α increases. In addition, the leakage power (the ratio of the leakage beam) may increase as the beam size W₀ increases. When the leakage power (the ratio of the leakage beam) is great, the cutting ability may be reduced by spreading of the focused laser beam.

FIG. 12 is a graph showing simulation results of a full width at half maximum (FWHM) obtained when using a stealth dicing apparatus according to some example embodiments of the inventive concepts. Referring to FIG. 12, the FWHM may decrease as the inclination angle α increases.

Referring to FIGS. 11 and 12, as the inclination angle α increases, the FWHM may decrease but the leakage power may increase. Thus, the inclination angle α of an appropriate level may be desired or required. In other words, the inclination angle α having an appropriate range may be desired or required to obtain both the FWHM of an appropriate level and the leakage power of an appropriate level.

FIG. 13 is a graph showing simulation results of an appropriate ratio of a refractive index of a linearly focusing lens and an inclination angle, obtained when using a stealth dicing apparatus according to some example embodiments of the inventive concepts.

Referring to FIG. 13, an axicon refractive index may mean the refractive index R of the linearly focusing lens. A range of the inclination angle α may be limited to obtain both the FWHM of an appropriate level and the leakage power (the ratio of the leakage beam) of an appropriate level. Even though the inclination angle α is constant, the FWHM and the ratio of the leakage beam may be changed depending on the refractive index R of the linearly focusing lens. Thus, to obtain both the FWHM and the ratio of the leakage beam which have the appropriate levels, the range of the inclination angle α may be represented by the following expression (1) with respect to the refractive index R of the linearly focusing lens.

34.97R²−146.6R+162.5<α<52.45R²−207.6R+224.9 expression (1) (degree)

In other words, in FIG. 13, an expression of an upper limit curved line may be 52.45R²−207.6R+224.9. An expression of a lower limit curved line may be 34.97R²−146.6R+162.5. When the inclination angle α is less than 52.45R²−207.6R+224.9, the ratio of the leakage beam may be in an allowable range. When the inclination angle α is greater than 34.97R²−146.6R+162.5, the FWHM may be in an allowable range. In other words, when the inclination angle α is in the range of the expression (1), both the FWHM and the ratio of the leakage beam may be maintained at appropriate levels. Thus, the intensity of the laser beam linearly focused in the wafer may be appropriate, and the cutting ability by the laser beam may be sufficiently secured. In some example embodiments, when the linearly focusing lens includes glass, the inclination angle α may range from 25 degrees to 35 degrees.

Since a Bessel beam is linearly focused, an intensity of the Bessel beam may be weaker than an intensity of a Gaussian beam focused to a point. Thus, a cutting ability of the Bessel beam to the wafer may be weak. To overcome this, a pulse width and average power of the Bessel beam may be controlled. In some example embodiments, the laser light source may generate pulse laser having a pulse width of 100 ns or less. In some example embodiments, the laser light source may generate pulse laser having an average power of 2 W or more. When the pulse width is 100 ns or less and the average power is 2 W or more, a sufficient cutting ability to the wafer may be secured. In some example embodiments, the FWHM may be about 1 μm to secure the sufficient cutting ability to the wafer. Thus, an aspect ratio (DOF:FWHM) of the laser beam may be 150 or more.

FIG. 14 is a graph showing simulation results of a temperature distribution in a wafer, obtained when using a stealth dicing apparatus according to some example embodiments of the inventive concepts.

Referring to FIG. 14, the graph may show temperature distributions according to a depth (z) of a wafer when a Gaussian beam and a Bessel beam are used. A pulse width of the Gaussian beam may be 150 ns. A pulse width of the Bessel beam may be 50 ns. When the Gaussian beam is used, the temperature may increase at only a certain depth of the wafer. On the contrary, when the Bessel beam is used, high temperature may be continuously distributed in the thickness direction of the wafer. In other words, when the Bessel beam is used, the high temperature may be applied to a linear region extending in the thickness direction of the wafer.

FIG. 15 is a graph showing simulation results of a stress distribution in a wafer, obtained when using a stealth dicing apparatus according to some example embodiments of the inventive concepts.

Referring to FIG. 15, the graph may show stress distributions according to a depth (z) of a wafer when a Gaussian beam and a Bessel beam are used. When the Gaussian beam is used, stress may occur at only a certain depth of the wafer. On the contrary, when the Bessel beam is used, high stress may be continuously distributed in the thickness direction of the wafer. In other words, when the Bessel beam is used, the high stress may be generated along the thickness direction of the wafer. Thus, when the Bessel beam is used, it is possible to form a crack line having a shape extending in the thickness direction of the wafer.

In the stealth dicing apparatus and method according to the example embodiments of the inventive concepts, the wafer may be cut by one process.

In the stealth dicing apparatus and method according to the example embodiments of the inventive concepts, a thick wafer may be cut.

In the stealth dicing apparatus and method according to the example embodiments of the inventive concepts, the wafer may be quickly and easily cut.

In the stealth dicing apparatus and method according to the example embodiments of the inventive concepts, the productivity may be improved while using the DBG method.

While the inventive concepts have been described with reference to example embodiments, it will be apparent to those skilled in the art that various changes and modifications may be made without departing from the spirits and scopes of the inventive concepts. Therefore, it should be understood that the above example embodiments are not limiting, but illustrative. Thus, the scopes of the inventive concepts are to be determined by the broadest permissible interpretation of the following claims and their equivalents, and shall not be restricted or limited by the foregoing description.

What is claimed is:

1. A stealth dicing apparatus comprising:
a laser light source; and
a linearly focusing lens configured to linearly focus a beam output from the laser light source, the linearly focusing lens including,
a horizontal surface; and
an inclined surface forming an inclination angle with the horizontal surface, the inclination angle satisfying an expression 34.97R²−146.6R+162.5<α<52.45R²−207.6R+224.9, where ‘α’ is the inclination angle and ‘R’ is a refractive index of the linearly focusing lens.

2. The stealth dicing apparatus of claim 1, further comprising:
a beam size adjuster configured to adjust a size of the beam output from the laser light source,
wherein the beam size adjuster is between the laser light source and the linearly focusing lens.

3. The stealth dicing apparatus of claim 2, wherein the beam size adjuster includes a front lens and a rear lens.

4. The stealth dicing apparatus of claim 3, wherein the front lens includes a variable thickness lens being configured to change shape such that a thickness of the variable thickness lens is changed.

5. The stealth dicing apparatus of claim 3, wherein the rear lens includes a variable position lens configured to change a position thereof such that a distance between the front lens and the rear lens is changed.

6. The stealth dicing apparatus of claim 2, wherein the linearly focusing lens is configured to be positioned such that a beam output from the beam size adjuster passes through the horizontal surface in a direction substantially perpendicular to the horizontal surface.

7. The stealth dicing apparatus of claim 6, wherein the inclined surface has a shape of a side surface of a cone.

8. The stealth dicing apparatus of claim 1, wherein the inclination angle (α) ranges from 25 degrees to 35 degrees.

9. The stealth dicing apparatus of claim 1, wherein an average power of the beam output from the laser light source is 2 W or more.

10. The stealth dicing apparatus of claim 1, wherein a pulse width of the beam output from the laser light source is 100 ns or less.

11. A stealth dicing apparatus comprising:
a laser light source; and
a linearly focusing lens configured to linearly focus a beam output from the laser light source, the linearly focusing lens including,
a cylindrical lens, and
a conical lens coupled to a bottom surface of the cylindrical lens, a side surface of the conical lens forming an inclination angle with the bottom surface of the cylindrical lens, and the inclination angle satisfying an expression 34.97R²−146.6R+162.5<α<52.45R²−207.6R+224.9, where ‘α’ is the inclination angle and ‘R’ is a refractive index of the linearly focusing lens.

12. The stealth dicing apparatus of claim 11, further comprising:
a beam size adjuster including a front lens and a rear lens,
wherein the beam size adjuster is between the laser light source and the linearly focusing lens.

13. The stealth dicing apparatus of claim 12, wherein the front lens includes a variable thickness lens being configured to change shape such that a thickness of the variable thickness lens is changed.

14. The stealth dicing apparatus of claim 12, wherein the rear lens includes a variable position lens configured to change a position thereof such that a distance between the front lens and the rear lens is changed.

15. A stealth dicing method comprising:
adjusting a size of a beam by controlling a beam size adjuster;
refracting the beam by a linearly focusing lens;
linearly focusing the refracted beam in a wafer; and
forming a crack in the wafer by the linearly focused beam,
wherein the linearly focusing lens includes,
a horizontal surface; and
an inclined surface forming an inclination angle with the horizontal surface, the inclination angle satisfying an expression 34.97R²−146.6R+162.5<α<52.45R²−207.6R+224.9, where ‘α’ is the inclination angle and ‘R’ is a refractive index of the linearly focusing lens.

16. The stealth dicing method of claim 15, wherein the inclination angle (α) ranges from 25 degrees to 35 degrees.

17. The stealth dicing method of claim 15, wherein the beam size adjuster includes a front lens and a rear lens.

18. The stealth dicing method of claim 17, wherein the rear lens includes a variable position lens configured to change a position thereof such that a distance between the front lens and the rear lens is changed.

19. The stealth dicing method of claim 17, wherein the front lens includes a variable thickness lens being configured to change shape such that a thickness of the variable thickness lens is changed.

20. The stealth dicing method of claim 15, wherein a pulse width of the beam incident on the wafer is 100 ns or less.
